(19) United States
(12) Patent Application Publication
(10) Pub. No.: US 2008/0001707 A1
(43) Pub. Date: Jan. 3, 2008

(54) Key with interruptible antenna for data security

(76) Inventors: Bryan Urben, Troy, MI (US); Ernie Mitchell, Sterling Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/594,311

(22) Filed: Nov. 8, 2006

Related U.S. Application Data
(60) Provisional application No. 60/814,750, filed on Jun. 19, 2006.

(51) Int. Cl. G05B 19/00

(52) U.S. Cl. 340/5.62; 340/572.3; 340/572.7; 340/5.61; 726/20

(57) ABSTRACT

An authorization device includes a transponder and antenna. Transmission prompts are received by the antenna and sent to the transponder. The transponder will then emit an identification signal utilized to verify and provide access to a locking device. The antenna is selectively connected to the transponder to control receipt of the transmission prompt. The example authorization device controls receipt of transmission prompts by a transponder to prevent unauthorized and undesired receipt and thereby transmission of identification and other signals.

### CROSS-REFERENCE TO RELATED APPLICATIONS

This application claims priority to U.S. Provisional Application Ser. No. 60/814,750 filed on Jun. 19, 2006.

### BACKGROUND OF THE INVENTION

This invention generally relates to a lock for a key including a radio frequency identification tag. More particularly, this invention relates to a security feature for preventing unauthorized interception of a key identification code.

Radio frequency identification (RFID) tags are electronic devices that transmit an identification signal in response to a transmission received from another source. A typical RFID tag does not require batteries because energy from the prompt transmission is utilized to send the response signal. As no batteries or other power source is required, RFID tags are increasingly being utilized in security applications.

One such application includes an RFID tag disposed within a key for receiving a transmission from a door lock. The door lock transmits a prompt signal that is received by the key. The RFID tag within the key in turn transmits a signal that is received by the lock. The lock uses the signal from the key to verify that that particular key is authorized to operate the lock. Further, the signal from the key can also be utilized to determine which key is being utilized to compile a record of keys, and in turn which user has operated a particular lock.

Disadvantageously, the RFID tag within the key will respond to a prompt signal of a particular modulation and frequency, regardless of whether or not that prompts transmission is actually from the lock or from another source. Therefore, an unauthorized prompt transmission could prompt transmission of a particular key's identification information at a substantial distance. That identification information is then potentially susceptible to unauthorized duplication and use.

Accordingly, it is desirable to develop and design a device that prevents the receipt and transmission of RFID tag data until desired for operation.

### SUMMARY OF THE INVENTION

An example authorization device includes a transponder and antenna. Transmission prompts are received by the antenna and sent to the transponder. The transponder will then emit an identification signal utilized to verify and provide access to a locking device. The antenna is selectively electrically connected to the transponder to control receipt of a transmission prompt.

A disclosed example authorization device is a key that includes the transponder that is capable of transmitting a radio frequency identification tag in response to receipt of a transmission prompt from a transmitter associated with a lock or other authorized device. The transmission prompt is received by the antenna, and the antenna is selectively engageable such that transmission prompts cannot be received until required for use.

A circuit within the authorization device is in a default open condition such that no transmission prompt can be received by the transponder. A switch is selectively actuated to allow communication of transmission prompts with the transponder. The transponder will then proceed to transmit the radio frequency identification (RFID) tag data to confirm authorization and allow opening of the lock.

In another disclosed example, the authorization device includes a shield that prevents receipt of transmission prompts. The shield moves away to expose the RFID tag to transmission prompts once inserted in the lock assembly or when it is desired to receive transmission prompts.

Accordingly, the example authorization device controls receipt of transmission prompts by a transponder to prevent unauthorized and undesired receipt and thereby transmission of identification and other signals.

The features of the present invention can be best understood from the following specification and drawings, the following of which is a brief description.

### BRIEF DESCRIPTION OF THE DRAWINGS

FIG. 1, is a schematic view of an example RFID tag key including a selectively engageable antenna.

FIG. 1A is schematic view of another example RFID tag key including a selectively engageable antenna.

FIG. 2, is a schematic view of another example RFID tag key including a selectively engageable antenna.

FIG. 3 is a schematic view of an example RFID tag key including a shielded antenna.

FIG. 4 is a front view of the example RFID tag key including the shielded antenna.

FIG. 5 is a schematic view of the example RFID tag key with the shield retracted.

FIG. 6 is a schematic view of another example RFID tag key including a selectively engageable antenna partially inserted into a key hole.

FIG. 7 is a schematic view of the example RFID tag key of FIG. 5 completely received within the key hole.

FIG. 8 is a schematic view of another example RFID tag key including a selectively engageable antenna partially inserted into a key hole.

FIG. 9 is a schematic side view of the example RFID tag key of FIG. 8 received into the key hole.

### DETAILED DESCRIPTION OF THE PREFERRED EMBODIMENT

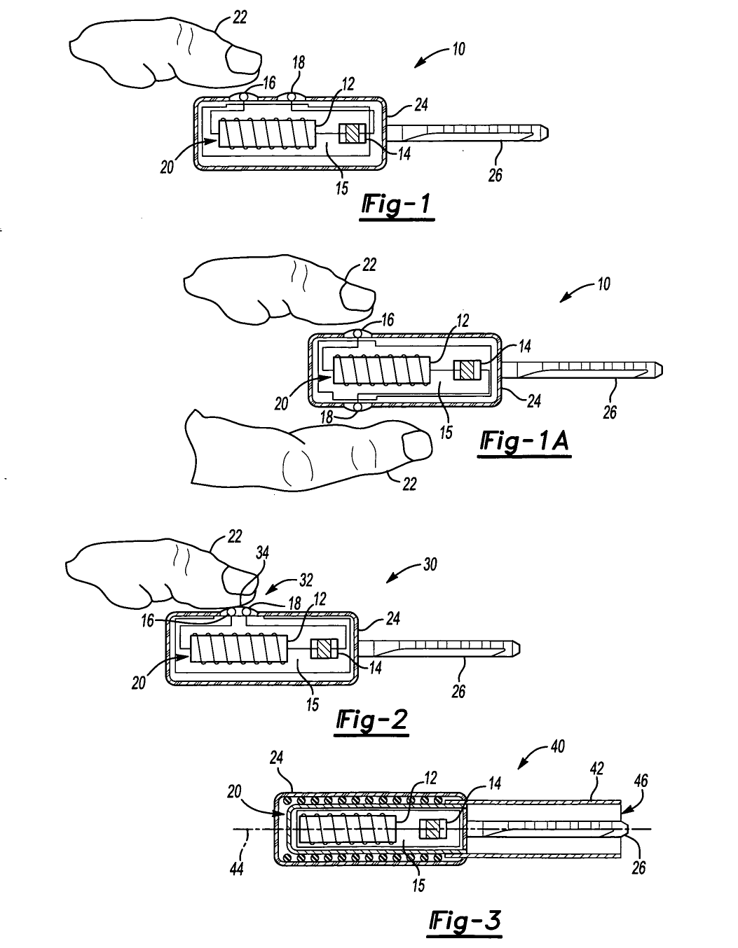

Referring to FIG. 1, a key 10 includes a transponder 14 that transmits data in response to receipt of a transmission prompt from a transmitter associated with a lock or other authorized device (not shown). The transmission prompt is received by an antenna 12. The antenna 12 includes a coil of wire that is in electrical communication with the transponder 14. The transponder 14 and antenna 12 comprise a circuit 20 that is disposed within a housing 24. In the disclosed example, the circuit 20 comprises a single substrate 15 including the transponder 14 and the antenna 12. The example substrate 15 is flexible, however other circuit substrates as are known are within the contemplation of this invention. The key 10 includes a shank 26 that includes a configuration that corresponds to a key hole of a lock.

The term transponder as utilized in this disclosure refers to the device or devices that receive an RF signal and produce an RF signal in reply. The example transponder 14 is powered by the RF signal; however it is within the contemplation of this invention to use a transponder including a dedicated power supply such as a battery, for example.

The antenna 12 is selectively engageable such that transmission prompts cannot be received until required for use of the key 10. The circuit 20 is in a default open condition such that no transmission prompt can be received by the transponder 14. That is no transmission prompt can be received until an electrical connection is made between a first contact 16 and a second contact 18. The electrical connection, in this example, between the first and second contacts 16, 18 is provided by a user's finger 22. During operation of the key 10 a user grips the key in a manner such that the user's finger 22 contacts both the first contact 16 and the second contact 18. The contact with the user's finger 22 completes the circuit 20, allowing receipt of the transmission prompt by the transponder. The transponder 14 will then proceed to transmit the radio frequency identification (RFID) tag to confirm authorization and allow opening of the lock.

Referring to FIG. 1A, the key 10 includes the first contact 16 on a side opposite the second contact 18. As appreciated, two fingers are then required to complete circuit 20. Because the contacts 16 and 18 are disposed on opposite sides of the housing 24, errant contact by an electrically conductive object such as another key or key ring is less likely to inadvertently complete the circuit to open the key 10 to receipt of transmission prompts.

Referring to FIG. 2, another RFID tag key 30 includes a button 32 that is depressed by a user to complete the circuit 20 and activate the antenna 12. The circuit 20 remains in an open position until such time as a user desires to use the key 30. At that time, depressing the button 32 causes the engagement of a contact 34 across the first and second contacts 16, 18 to complete the circuit and allow receipt of the transmission prompt. With the button 34 in the default open position, the circuit 20 remains open and no transmission prompt can be received. Thereby, unauthorized or undesired transmission prompts cannot cause the transponder to send a signal that can be intercepted and utilized in an undesirable and unauthorized manner.

Referring to FIG. 3, another RFID key 40 includes an electromagnetic frequency (EMF) shield 42 that prevents the receipt of transmission prompts. In the disclosed example, the EMF shield 42 surrounds the antenna 12 on all sides but for along an axis 44 of the key 40.

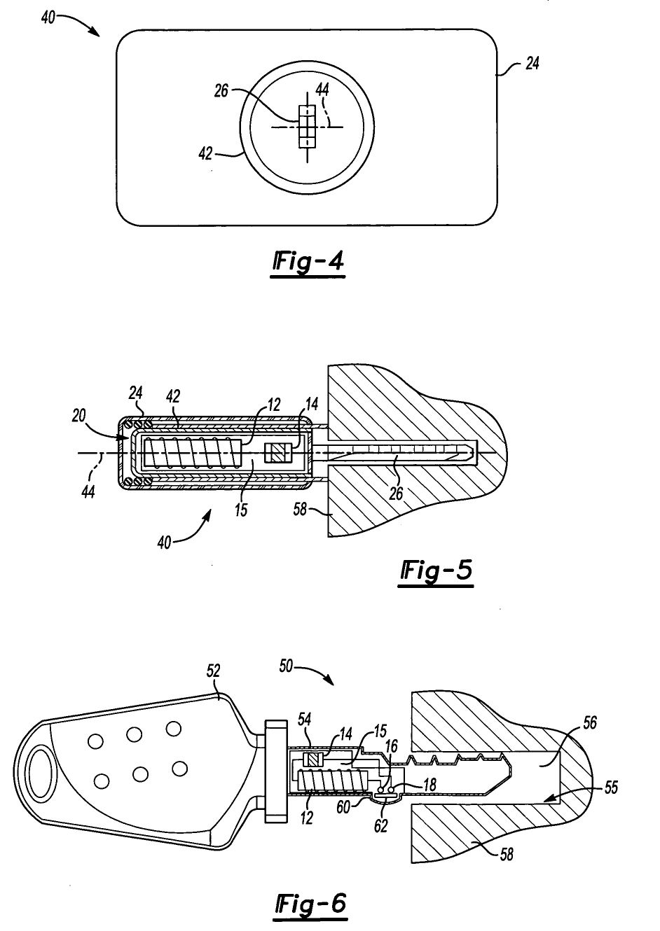

Referring to FIG. 4, in the disclosed example, the EMF shield 42 surrounds the shaft 26 and the antenna 12 within the housing 24. The EMF shield 42 is disposed substantially concentric about the axis 44. The EMF shield 42 blocks transmission prompts from being received and thereby prevents undesired transmission from the transponder 14.

Referring to FIG. 5, the EMF shield 42 is movable upon insertion of the key into a lock housing 58. With the EMF shield 42 slide out of blocking position, transmission prompts from the lock are receivable. Upon removal of the RFID key 40 from the lock, the EMF shield 42 slides back into blocking position to prevent undesired communication with the transponder 14. In the illustrated example, the EMF shield 42 moves responsive to being received within the lock housing 58. The EMF shield 42 may also be movable when removed from the lock by positively moving the EMF shield 42. However, in a passive condition, the EMF shield 42 would remain in the extended and blocking conditions.

Referring to FIG. 6, another RFID key 50 includes a shank 54 extending from a housing 52. The shank 54 is received within a key hole opening 56 of a lock housing 58. The shank 54 includes a button 60 that engages an inner surface 55 of the opening 56 to complete the circuit between the antenna 12 and the transponder 14. The antenna 12 and transponder 14 are not in electrical communication in a default condition. Accordingly, transmission prompts are not received in this default condition.

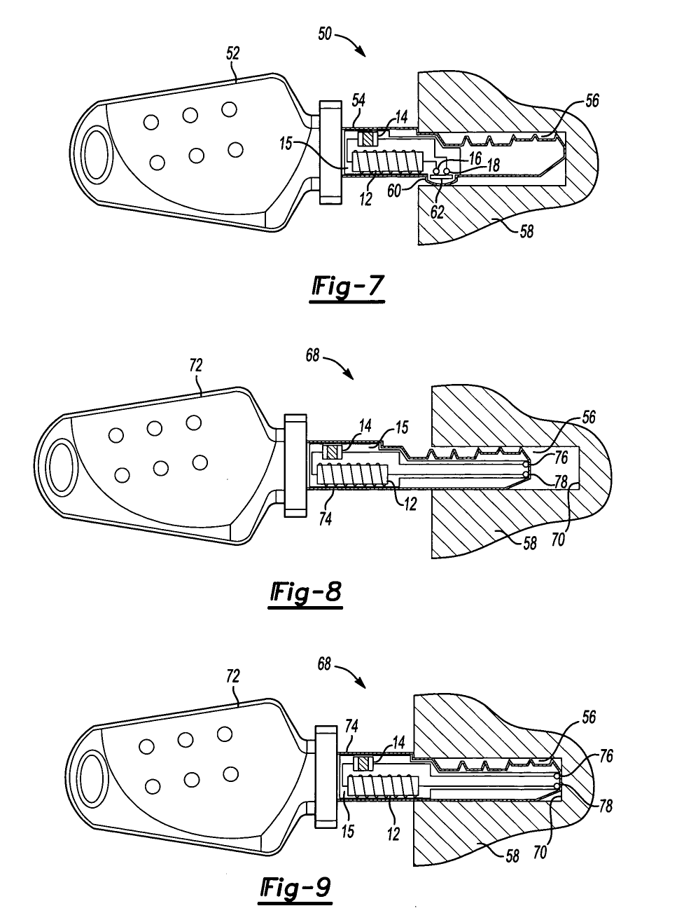

Referring to FIG. 7, the shank 54 is shown received more completely within the key hole 56, such that the button 60 is depressed responsive to contact with the inner surface 55. In this way, the key 50 is only able to receive transmission prompts when received within the lock, and thereby, substantially prevents unauthorized or undesired receipt and transmission of identification signals.

Referring to FIG. 8, another example RFID key 68 is shown and includes a first contact 76 and a second contact 78 that are in a default open condition; such that transmission prompt signals are not receivable by the antenna 12. The key 68 includes a shank 74 extending from a housing 72. The first and second contacts 76, 78 are disposed on the outside surface of the shank 74. The circuit between the transponder 14 and the antenna 12 remains open until such time as the contacts 76, 78 are closed. The key hole 56 includes a contact surface 70 that corresponds with key contacts 76, 78.

Referring to FIG. 9, the disclosed key 68 is shown received within the key hole 56 such that the first and second contacts 76, 78 are engaged with the contact surface 70 to complete the circuit within the key 68. In this position, the key 68 is ready and capable of receiving transmission prompts. Once the transmission prompts are received the transponder 14 is free to send the identification code for receipt by the lock.

Accordingly, the example key according to this invention provides a selectively engageable antenna to prevent unauthorized and undesired receipt and thereby transmission of identification and other signals.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An RFID tag authorization device comprising:
a transponder for sending a signal responsive to receipt of a transmission prompt; and
an antenna selectively connected to the transponder for receiving the transmission prompt.

2. The RFID tag authorization device as recited in claim 1, including a switch selectable between an open position where the antenna is not in communication with the transponder and a closed position where the antenna is in communication with the transponder.

3. The RFID tag authorization device as recited in claim 1, wherein the switch comprises a first contact and a second contact that are engageable by a user to provide said closed position.

4. The RFID tag authorization device as recited in claim 1, wherein the switch comprises a button selectable by a user.

5. The RFID tag authorization device as recited in claim 1, wherein the switch comprises a first contact and a second contact that engages a portion of the lock to provide the closed position.

6. The RFID tag authorization device as recited in claim 1, wherein the switch comprises a first contact and a second contact that is closed by a user touching both the first contact and the second contact simultaneously.

7. The RFID tag authorization device as recited in claim 1, wherein the authorization device comprises a key that is received within a lock.

8. The RFID tag authorization device as recited in claim 1, wherein the transponder and antenna are mounted to a circuit substrate.

9. The RFID tag authorization device as recited in claim 8, wherein the circuit substrate comprises a switch selectable between an open position where the antenna is not in communication with the transponder, and a closed position where the antenna is in communication with the transponder.

10. A lock assembly comprising:
a locking device including a transceiver for emitting a prompt signal and receiving an identification signal; and
an authorization device that emits an identification signal including an antenna in selective communication with a transponder.

11. The assembly as recited in claim 10, wherein the authorization device includes a switch for controlling communication between the transponder and the antenna.

12. The assembly as recited in claim 11, wherein the switch is actuated to a position enabling communication between the transponder and the antenna by contact with a portion of the locking device.

13. The assembly as recited in claim 11, wherein the transponder, antenna and switch are all mounted to a common circuit substrate.

14. The assembly as recited in claim 10, wherein the switch comprises a first contact and a second contact, and the lock device includes a conductive member contactable with the first and second contacts such that the antenna is placed in communication with the antenna when the authorization device is received within the lock device.

15. The assembly as recited in claim 10, wherein the authorization device comprises a key that is receivable within the lock assembly.

16. A method of protecting identification information stored within an authorization device comprising the steps of:
a) selectively connecting an antenna with a transponder to control receipt of a prompt signal by the transponder.

17. The method as recited in claim 16, including the step of connecting the antenna with the transponder responsive to the authorization device being received within a locking device.

18. The method as recited in claim 16, including actuating a switch disposed on the authorization device.

19. The method as recited in claim 16, including connecting the antenna to the transponder by bridging a gap between a first contact and a second contact with a portion of a user.

20. An RFID tag authentication device comprising:
a transponder for sending a signal responsive to receipt of a transmission prompt;
an antenna connected to the transponder for receiving the transmission prompt; and
a shield at least partially surrounding the antenna and transponder for controlling a receipt of incoming transmission prompts and outgoing signals from the transponder are received and transmitted.

21. The RFID tag authentication device as recited in claim 20, wherein the shield is movable to allow receipt of incoming transmission prompts and transmission of outgoing signals.

22. The RFID tag authentication device as recited in claim 20, wherein the authentication device comprises a key including a blade for engaging a locking device.
